(19) United States
(12) Patent Application Publication
(10) Pub. No.: US 2011/0193786 A1
(43) Pub. Date: Aug. 11, 2011

(54) TOUCHSCREEN DISPLAYS FOR AN ELECTRONIC DEVICE THAT INCLUDE SEPARATE CARBON NANOTUBE LAYERS FOR DETERMINING LOCATION AND FORCE, RESPECTIVELY

(75) Inventors: Paul Futter, Cary, NC (US); Per Holmberg, Dalby (SE); Gunnar Klinghult, Lund (SE)

(73) Assignee: Sony Ericsson Mobile Communications AB

(21) Appl. No.: 12/702,029

(22) Filed: Feb. 8, 2010

(51) Int. Cl. G06F 3/041

(52) U.S. Cl. 345/173; 977/952

(57) ABSTRACT

A touchscreen display for an electronic device comprises a dielectric layer that is substantially transparent and configured to display information therethrough, a first carbon nanotube (CNT) layer disposed on the dielectric layer and being operable to facilitate determination of a location of contact with the touchscreen display, and a second CNT layer disposed on the dielectric layer and being operable to facilitate determination of force associated with contact of the touchscreen display.

### BACKGROUND OF THE INVENTION

The present invention relates to electronic devices, and, more particularly, to methods, electronic devices that include a touchscreen display.

Electronic devices, such as cellular phones, often have user interfaces that incorporate a touchscreen for inputting information and/or making selections. Some devices use a touchscreen that provides both position sensing (e.g., X and Y axis information) along with pressure sensing (e.g., Z axis information). Unfortunately, the technology used to provide pressure sensing may have both electrical and mechanical limitations.

### SUMMARY

According to some embodiments of the present invention, a touchscreen display for an electronic device comprises a dielectric layer that is substantially transparent and configured to display information therethrough, a first carbon nanotube (CNT) layer disposed on the dielectric layer and being operable to facilitate determination of a location of contact with the touchscreen display, and a second CNT layer disposed on the dielectric layer and being operable to facilitate determination of force associated with contact of the touchscreen display.

In other embodiments, the first and second CNT layers do not overlap with each other.

In still other embodiments, the second CNT layer is disposed at a periphery of the dielectric layer.

In still other embodiments, the second CNT layer is disposed continuously along an outer border of the dielectric layer.

In still other embodiments, the second CNT layer is disposed at discrete locations along an outer border of the dielectric layer.

In still other embodiments, the dielectric layer comprises at least one vertex proximate to where lines defined by edges of the dielectric layer intersect and the second CNT layer is disposed at the at least one vertex

In still other embodiments, the dielectric layer has a first portion that is substantially transparent and is configured to display information therethrough and a second portion that is not configured to display information therethrough.

In still other embodiments, the first CNT layer is disposed on the first portion of the dielectric layer and the second CNT layer is disposed on the second portion of the dielectric layer.

In still other embodiments, the second CNT layer has a thickness as measured in a direction substantially perpendicular to the dielectric layer that is greater than a thickness of the first CNT layer as measured in a direction substantially perpendicular to the dielectric layer.

In still other embodiments, the thickness of the second CNT layer is about 1 μm.

In still other embodiments, the thickness of the first CNT layer is about 50 nm.

In still other embodiments, the electronic device is a mobile terminal.

In further embodiments of the present invention, a touchscreen display for an electronic device comprises a dielectric layer that is substantially transparent and configured to display information therethrough, a first carbon nanotube (CNT) layer disposed on the dielectric layer and being operable to facilitate determination of a location of contact with the touchscreen display, and a second CNT layer disposed on the dielectric layer and being operable to facilitate determination of force associated with contact of the touchscreen display, wherein the first and second CNT layers overlap each other.

In still further embodiments, the second CNT layer is configured as a strain gauge such that an electrical resistance of the second CNT layer changes responsive to deformation of the second CNT layer.

In still further embodiments, the second CNT layer comprises a plurality of second CNT layers and the plurality of second CNT layers overlap the first CNT layer.

In still further embodiments, a combined thickness of the first and second CNT layers is about 1 μm.

In still further embodiments, the electronic device is a mobile terminal.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates an electronic device/mobile terminal in accordance with some embodiments of the present invention; and

FIGS. 2-5 are plan views of a touchscreen for an electronic device that includes separate carbon nanotube layers for providing both position and force sensing, respectively, in accordance with various embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. In addition, it will be understood that when a layer is referred to as being “on” another layer or a substrate, it may be directly on another layer or substrate or intervening layers may be present. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Example embodiments are described herein with reference to cross-sectional illustrations and/or plane illustrations that are schematic illustrations of idealized embodiments of example embodiments. In drawings, the thickness of layers and regions is exaggerated to effectively describe technical details. Accordingly, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

For purposes of illustration, embodiments of the present invention are described herein in the context of a mobile terminal. It will be understood, however, that the present invention is not limited to such embodiments and may be embodied generally as an electronic device that includes a touchscreen user interface that a user can use to input information and/or make selections.

Some embodiments of the present invention stem from a realization that carbon nanotubes (CNTs) have both conductive and piezoresistive properties. The piezoresistive effect refers to the property of the electrical resistance of a material changing responsive to applied mechanical stress. Studies have shown that single walled CNT membranes have a gauge factor, which is a measure of the piezoresistivity of the material, approximately 2.0-2.5 times that of a silicon substrate. Moreover, silicon generally has a gauge factor approximately 100 times that of conventional strain gauge resistors. Accordingly, embodiments of the present invention comprise a touchscreen display that incorporates a first CNT layer that can be used to provide, for example, a resisitive or capacitive sensing functionality to determine the location of contact on the touchscreen display and a second CNT layer that can be used to provide force sensing functionality to make a determination of the force applied when contact is made with the touchscreen display. The high gauge factor associated with CNTs may allow the CNT layer used to provide the force sensing functionality to be made relatively small and still provide comparable performance to conventional force or mechanical stress sensors.

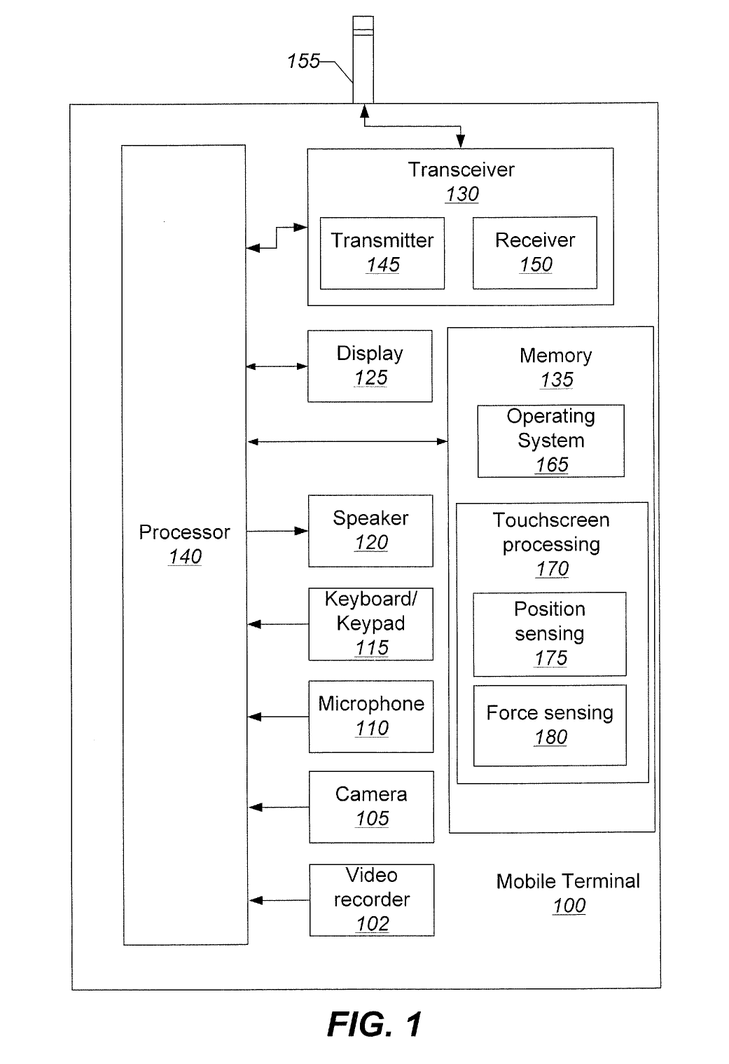

Referring now to FIG. 1, an exemplary mobile terminal 100, in accordance with some embodiments of the present invention, comprises a video recorder 102, a camera 105, a microphone 110, a keyboard/keypad 115, a speaker 120, a display 125, a transceiver 130, and a memory 135 that communicate with a processor 140. The display 125 may be a touchscreen display in which a user may input information and/or make selections by making contact with the display. The transceiver 130 comprises a transmitter circuit 145 and a receiver circuit 150, which respectively transmit outgoing radio frequency signals to base station transceivers and receive incoming radio frequency signals from the base station transceivers via an antenna 155. The radio frequency signals transmitted between the mobile terminal 100 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The foregoing components of the mobile terminal 100 may be included in many conventional mobile terminals and their functionality is generally known to those skilled in the art.

The processor 140 communicates with the memory 135 via an address/data bus. The processor 140 may be, for example, a commercially available or custom microprocessor. The memory 135 is representative of the one or more memory devices containing the software and data used to process sensor information to determine both a location and a force associated with contact made with the touchscreen display 125, in accordance with some embodiments of the present invention. The memory 135 may include, but is not limited to, the following types of devices: cache, ROM, PROM, EPROM, EEPROM, flash, SRAM, and DRAM.

As shown in FIG. 1, the memory 135 may contain up to two or more categories of software and/or data: the operating system 165 and a touchscreen processing module 170. The operating system 165 generally controls the operation of the mobile terminal 100. In particular, the operating system 165 may manage the mobile terminal's software and/or hardware resources and may coordinate execution of programs by the processor 140. The touchscreen processing module 170 comprises a position sensing module 175 and a force sensing module 180. The position sensing module 175 may be configured to process sensor data that are generated responsive to operation of a first CNT layer comprising part of the touchscreen display 125 that is operable to provide resistive or capacitive sensing to determine the location of contact on the touchscreen display 125. The force sensing module 180 may be configured to process sensor data that are generated responsive to operation of a second CNT layer comprising part of the touchscreen display 125 that is operable to provide force sensing to make a determination of the force applied when contact is made with the touchscreen display 125.

Although FIG. 1 illustrates an exemplary software and hardware architecture that may be used to support a touchscreen for an electronic device that includes separate carbon nanotube layers for providing both position and force sensing, respectively, it will be understood that the present invention is not limited to such a configuration but is intended to encompass any configuration capable of carrying out the operations described herein. Moreover, the functionality of the hardware/software architecture of FIG. 1 may be implemented as a single processor system, a multi-processor system, or even a network of stand-alone computer systems, in accordance with various embodiments of the present invention.

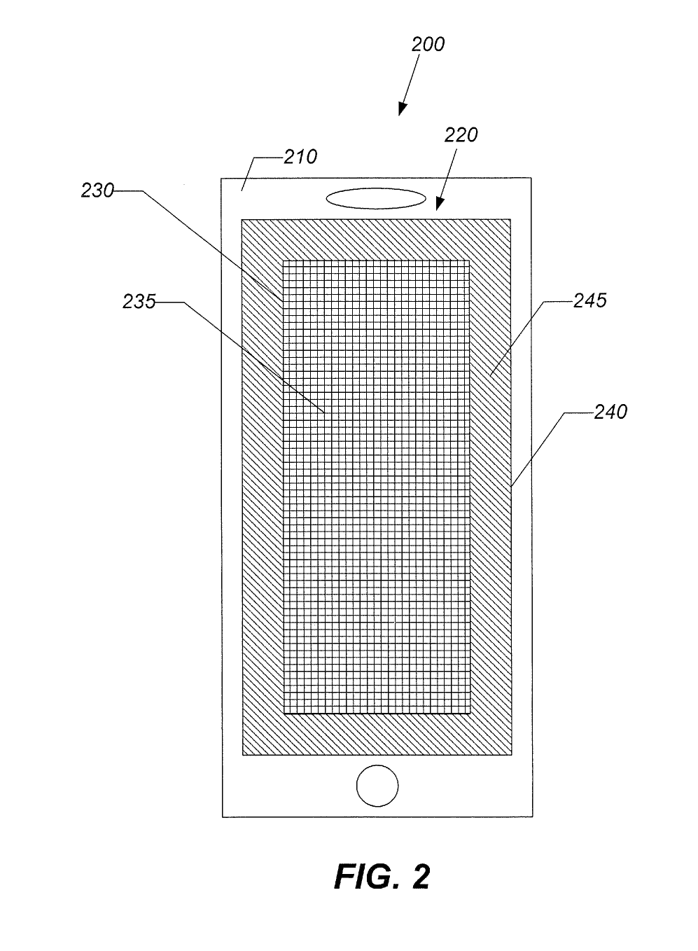

Referring now to FIGS. 2-5, various embodiments of electronic devices having touchscreen displays incorporating separate CNT layers to support determination of a location of contact with the touchscreen and determination of force associated with the contact of the touchscreen, respectively, will now be described. FIG. 2 illustrates a mobile terminal 200 having a housing 210 and a touchscreen display 220. The touchscreen display 220 comprises a dielectric layer, such as plastic or glass, and includes a first portion 230 that is substantially transparent and is configured to display information therethrough and a second portion 240 that is not configured to display information therethrough. The first portion 230 has a first CNT layer 235 disposed thereon that is operable to facilitate determination of a location of contact with the touchscreen display 220. The first CNT layer 235 may, for example, be configured as part of a structure including the dielectric layer and one or more other conducting layers to facilitate resistive or capacitive sensing functionality to determine the location where contact is made with the touchscreen display 220.

The second portion 240 includes a second CNT layer 245 disposed thereon that is operable to facilitate determination of the force with which the touchscreen display is contacted. As shown in FIG. 2, the first and second CNT layers 235, 245 do not overlap each other and the second CNT layer 245 is disposed at the periphery of the dielectric layer in a region of the touchscreen display 220 that is not used to display information therethrough. Because the second portion 240 of the touchscreen display is not used to display information and the first portion 230 of the touchscreen display is used to display information, the second CNT layer 245 may be thicker than the first CNT layer 235 when measured in a direction that is substantially perpendicular to the dielectric layer. In accordance with some embodiments of the present invention, the thickness of the first CNT layer 235 may have a thickness of about 50 nm and the thickness of the second CNT layer 245 may have a thickness of about 1 μm. The increased thickness of the second CNT layer 245 may improve the sensitivity of the second CNT layer 245 to the force applied when the touchscreen 220 is contacted.

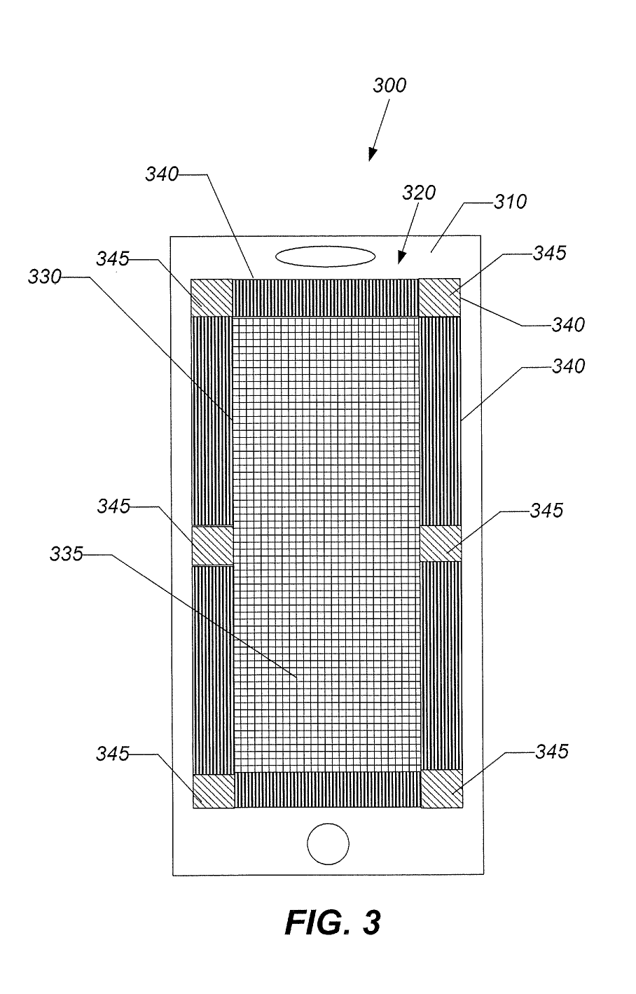

FIG. 3 illustrates a mobile terminal 300 that includes a housing 310 and a touchscreen display 320 that is configured similarly to the touchscreen display 220 of FIG. 2 except for the arrangement of the second CNT layer 345 in the region of the touchscreen display that is not used to display information therethrough 340. The touchscreen display 320 comprises a dielectric layer, such as plastic or glass, and includes a first portion 330 that is substantially transparent and is configured to display information therethrough and a second portion 340 that is not configured to display information therethrough. The first portion 330 has a first CNT layer 335 disposed thereon that is operable to facilitate determination of a location of contact with the touchscreen display 320. The first CNT layer 335 may, for example, be configured as part of a structure including the dielectric layer and one or more other conducting layers to facilitate resistive or capacitive sensing functionality to determine the location where contact is made with the touchscreen display 320.

The second portion 340 includes a second CNT layer 345 disposed thereon that is operable to facilitate determination of the force with which the touchscreen display is contacted. As shown in FIG. 3, the first and second CNT layers 335, 345 do not overlap each other and the second CNT layer 345 is disposed at discrete locations around the periphery of the dielectric layer in a region of the touchscreen display 320 that is not used to display information therethrough 340. In the example shown, the second CNT layer 345 is disposed at the four corners (i.e., four vertices defined by intersection of the edges of the touchscreen display 320) and along two sides of the touchscreen display 320.

For purposes of illustration, both the first and second CNT layers 335, 345 appear to be disposed on top of the dielectric layer (e.g., glass or plastic structure) on the outside of the mobile terminal 200, 300 in FIGS. 2 and 3. It will be understood, however, that embodiments of the present invention are not limited to such a configuration. For example, the first CNT layer 335 used to facilitate the determination of contact locations with the touchscreen display may be disposed on top of the dielectric layer on the outside of the mobile terminal 200, 300 while the second CNT layer 345 used to facilitate the determination of the force associated with contact of the touchscreen display may be disposed underneath the dielectric layer on the inside of the mobile terminal 200, 300.

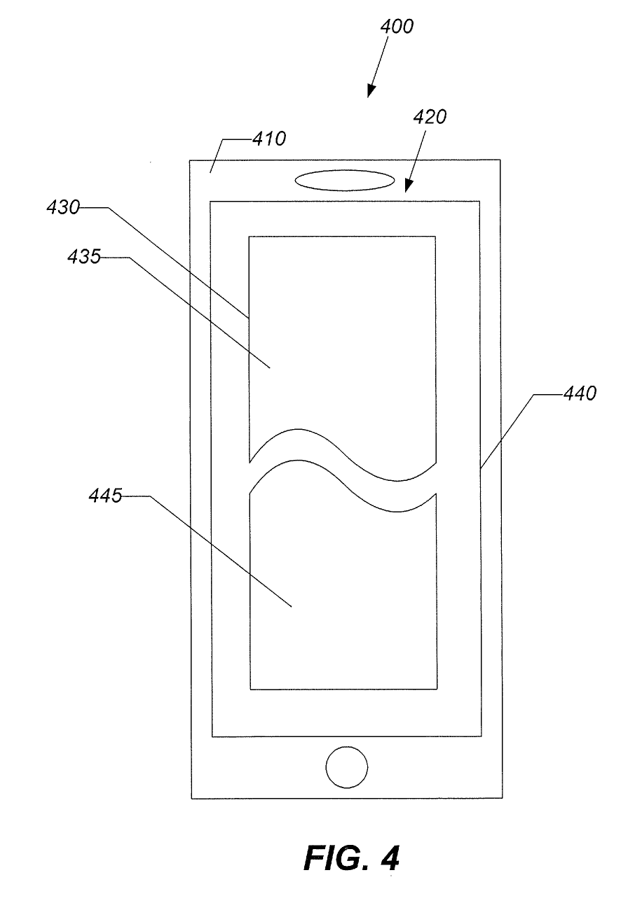

FIG. 4 illustrates a mobile terminal 400 that includes a housing 410 and a touchscreen display 420 according to further embodiments of the present invention. In contrast to the embodiments described above with respect to FIGS. 2 and 3, the touchscreen display 420 comprises a dielectric layer, such as plastic or glass, and includes a first portion 430 that is substantially transparent and is configured to display information therethrough and a second portion 440 that is not configured to display information therethrough. The first portion has both a first CNT layer 435 disposed thereon that is operable to facilitate determination of a location of contact with the touchscreen display 420 and a second CNT layer 445 disposed thereon that is operable to facilitate determination of the force with which the touchscreen display is contacted. The first CNT layer 435 may, for example, be configured as part of a structure including the dielectric layer and one or more other conducting layers to facilitate resistive or capacitive sensing functionality to determine the location where contact is made with the touchscreen display 420.

As shown in FIG. 4, the first and second CNT layers 435 and 445 overlap each other in the region of the touchscreen display 420 used to display information therethrough 430. The second CNT layer 445 may be configured in a manner similar to the structure of a strain gauge resistor according to some embodiments of the present invention. The dielectric layer may act as a membrane and the force associated with contact to the touchscreen display 420 may cause a strain in this membrane, which can be measured based on the change in electrical resisitivity of the second CNT layer 445.

Because both the first and second CNT layers 435 and 445 are disposed in the region of the touchscreen display 420 in which information is displayed 430, their thicknesses may be sufficiently thin to allow for suitable visibility. In accordance with some embodiments of the present invention, the combined thickness of the first CNT layer 435 and the second CNT layer 445 may be about 1 μm. These thicknesses are measured in a direction substantially perpendicular to the dielectric layer.

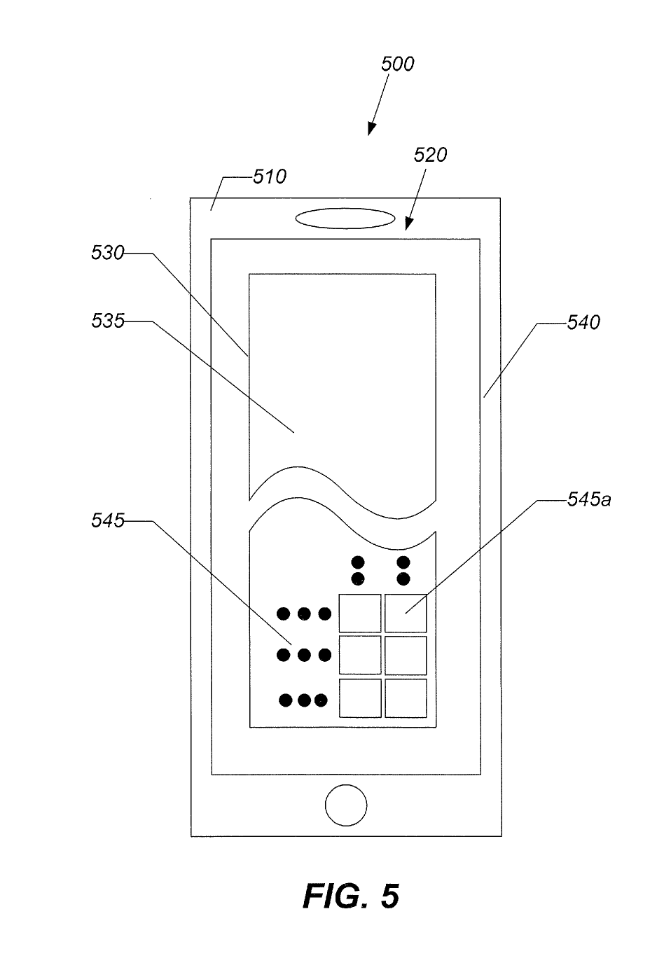

FIG. 5 illustrates a mobile terminal 500 that includes a housing 510 and a touchscreen display 520 that is configured similarly to the touchscreen display 420 of FIG. 4 except for the arrangement of the second CNT layer 445 in the region of the touchscreen display that is used to display information therethrough.

The touchscreen display 520 comprises a dielectric layer, such as plastic or glass, and includes a first portion 530 that is substantially transparent and is configured to display information therethrough and a second portion 540 that is not configured to display information therethrough. The first portion has both a first CNT layer 535 disposed thereon that is operable to facilitate determination of a location of contact with the touchscreen display 520 and a second CNT layer 545 disposed thereon that is operable to facilitate determination of the force with which the touchscreen display is contacted. The first CNT layer 535 may, for example, be configured as part of a structure including the dielectric layer and one or more other conducting layers to facilitate resistive or capacitive sensing functionality to determine the location where contact is made with the touchscreen display 420.

As shown in FIG. 5, the first and second CNT layers 535 and 545 overlap each other in the region of the touchscreen display 520 used to display information therethrough. In contrast to the configuration of FIG. 4, the second CNT layer 545 may comprise a plurality of layers 545a each configured as piezoresistive resistors that are electrically responsive to the deformation of the dielectric layer due to the application of force.

Because both the first and second CNT layers 535 and 545 are disposed in the region of the touchscreen display 520 in which information is displayed 530, their thicknesses may be sufficiently thin to allow for suitable visibility. In accordance with some embodiments of the present invention, the combined thickness of the first CNT layer 535 and each of the second CNT layers 545a may be about 1 μm. These thicknesses are measured in a direction substantially perpendicular to the dielectric layer

For purposes of illustration, both the first and second CNT layers appear to be disposed on top of the dielectric layer (e.g., glass or plastic structure) on the outside of the mobile terminal 400, 500 in FIGS. 4 and 5. It will be understood, however, that embodiments of the present invention are not limited to such a configuration. For example, the first CNT layer used to facilitate the determination of contact locations with the touchscreen display may be disposed on top of the dielectric layer on the outside of the mobile terminal 400, 500 while the second CNT layer used to facilitate the determination of the force associated with contact of the touchscreen display may be disposed underneath the dielectric layer on the inside of the mobile terminal 400, 500.

In the embodiments described above, the touchscreen display can be calibrated to account for the difference in the relative stiffness of the dielectric layer (i.e., glass or plastic layer of the display) at various locations. For example, the dielectric layer may be stiffer near the housing of the device than it is in the center of the device. Because a relative measurement of force is sufficient for most applications, a user may touch the display in particular locations with various degrees of force to calibrate the force sensing electronics in the device. Depending on the needed accuracy, calibration can be performed for each touchscreen display and the parameters associated with force sensitivity may be stored in each individual device's memory. Alternatively, if a wider tolerance of force sensitivity is acceptable, a force calibration may be performed for a single touchscreen display and all devices incorporating the touchscreen may use same force sensitivity parameters.

Many variations and modifications can be made to the preferred embodiments without substantially departing from the principles of the present invention. All such variations and modifications are intended to be included herein within the scope of the present invention, as set forth in the following claims.

That which is claimed:

1. A touchscreen display for an electronic device, comprising:
a dielectric layer that is substantially transparent and configured to display information therethrough;
a first carbon nanotube (CNT) layer disposed on the dielectric layer and being operable to facilitate determination of a location of contact with the touchscreen display; and
a second CNT layer disposed on the dielectric layer and being operable to facilitate determination of force associated with contact of the touchscreen display.

2. The touchscreen display of claim 1, wherein the first and second CNT layers do not overlap with each other.

3. The touchscreen display of claim 2, wherein the second CNT layer is disposed at a periphery of the dielectric layer.

4. The touchscreen display of claim 3, wherein the second CNT layer is disposed continuously along an outer border of the dielectric layer.

5. The touchscreen display of claim 3, wherein the second CNT layer is disposed at discrete locations along an outer border of the dielectric layer.

6. The touchscreen display of claim 5, wherein the dielectric layer comprises at least one vertex proximate to where lines defined by edges of the dielectric layer intersect and wherein the second CNT layer is disposed at the at least one vertex.

7. The touchscreen display of claim 1, wherein the dielectric layer has a first portion that is substantially transparent and is configured to display information therethrough and a second portion that is not configured to display information therethrough.

8. The touchscreen display of claim 7, wherein the first CNT layer is disposed on the first portion of the dielectric layer and the second CNT layer is disposed on the second portion of the dielectric layer.

9. The touchscreen display of claim 8, wherein the second CNT layer has a thickness as measured in a direction substantially perpendicular to the dielectric layer that is greater than a thickness of the first CNT layer as measured in a direction substantially perpendicular to the dielectric layer.

10. The touchscreen display of claim 9, wherein the thickness of the second CNT layer is about 1 μm.

11. The touchscreen display of claim 9, wherein the thickness of the first CNT layer is about 50 nm.

12. The touchscreen display of claim 1, wherein the electronic device is a mobile terminal.

13. A touchscreen display for an electronic device, comprising:
a dielectric layer that is substantially transparent and configured to display information therethrough;
a first carbon nanotube (CNT) layer disposed on the dielectric layer and being operable to facilitate determination of a location of contact with the touchscreen display; and
a second CNT layer disposed on the dielectric layer and being operable to facilitate determination of force associated with contact of the touchscreen display;
wherein the first and second CNT layers overlap each other.

14. The touchscreen display of claim 13, wherein the second CNT layer is configured as a strain gauge such that an electrical resistance of the second CNT layer changes responsive to deformation of the second CNT layer.

15. The touchscreen display of claim 13, wherein the second CNT layer comprises a plurality of second CNT layers;
wherein the plurality of second CNT layers overlap the first CNT layer.

16. The touchscreen display of claim 13, wherein a combined thickness of the first CNT layer and the second CNT layer is about 1 μm.

17. The touchscreen display of claim 13, wherein the electronic device is a mobile terminal.
